(19) United States
(12) Patent Application Publication
(10) Pub. No.: US 2024/0224986 A9
(43) Pub. Date: Jul. 11, 2024

(54) Plant Protection Device

(71) Applicant: Jill Bliss, Cedar Rapids, IA (US)

(72) Inventor: Jill Bliss, Cedar Rapids, IA (US)

(21) Appl. No.: 18/470,065

(22) Filed: Sep. 19, 2023

Related U.S. Application Data
(60) Provisional application No. 63/418,202, filed on Oct. 21, 2022.

(51) Int. Cl. A01M 29/10

(52) U.S. Cl. CPC A01M 29/10

(57) ABSTRACT

The present invention relates generally to the field of plant covers. More specifically, the present invention relates to a plant protection device. The device is comprised of a center attachment member, at least one protective arm, and at least one hook. The protective arm is removable from the center attachment member via at least one protective arm fasteners. The protective arm is comprised of an adjustable member and a stationary member. The adjustable member can be adjusted to a plurality of locations to encompass a plurality of plants. The adjustable member is secured at the desired length via a locking mechanism. The device is also comprised of a plurality of hooks that are inserted into the ground to secure the device.

### CROSS-REFERENCE TO RELATED APPLICATION

The present application claims priority to, and the benefit of, U.S. Provisional Application No. 63/418,202, which was filed on Oct. 21, 2022, and is incorporated herein by reference in its entirety.

### FIELD OF THE INVENTION

The present invention relates generally to the field of plant covers. More specifically, the present invention relates to a plant protection device comprised of a center attachment member, at least one protective arm, and at least one hook. The protective arm is removable from the center attachment member via at least one protective arm fastener. The protective arm is comprised of an adjustable member and a stationary member. The adjustable member can be adjusted to a plurality of positions to encompass a plurality of plants. The adjustable member is secured at the desired length via a locking mechanism. The device is also comprised of a plurality of hooks that are inserted into the ground to secure the device. The device may also be comprised of a light source and a motion sensor to repel unwanted animals at night. The light source is further powered by at least one battery. Accordingly, the present disclosure makes specific reference thereto. Nonetheless, it is to be appreciated that aspects of the present invention are also equally applicable to other like applications, devices, and methods of manufacture.

### BACKGROUND

Trying to get plants or a garden to grow can be a stressful and exhausting experience. Many animals often destroy small plants within a garden before they can ever fully grow. It can be costly to fence in large gardens or other plants. It can also be an eyesore to have fencing around every plant in an individual's yard. Further, even if a fence surrounds a garden, animals can still access the plant by chewing through the fence or digging holes under the fence. Pets, such as dogs, can also destroy an individual's gardens and plants. Further, dogs can dig large, deep holes throughout an individual's yard. It is common for dogs to return to the same holes they have started to dig and continue digging these holes to be large deep craters. These holes can be hazardous and cause serious injury if an individual steps into one or drives a mower into a hole. There exist no ways to successfully stop animals from digging up plants and gardens without creating massive eyesores in an individual's yard. Further, there exists no way to stop dogs from digging giant holes throughout an individual's yard.

Therefore, there exists a long-felt need in the art for a plant protection device. There is also a long-felt need in the art for a device that stops animals from digging up plants and gardens. There also exists a long-felt need in the art for a device which helps protect growing plants while remaining visually appealing. There also exists a long-felt need in the art for a plant protection device that can be easily installed with minimal effort. Further, there exists a long felt need in the art for a device that can restrict pets, such as dogs, from digging large holes throughout an individual's yard. Finally, there exists a long-felt need in the art for a device that is cost efficient and is not a burden on the user.

The subject matter disclosed and claimed herein, in one embodiment thereof, comprises a plant protection device. The device is comprised of a center attachment member, at least one protective arm, and at least one hook. The protective arm is comprised of an adjustable member and a stationary member. The adjustable member can be adjusted to a plurality of locations to encompass a plurality of plants, wherein the device is placed around the plant. The device is also comprised of a plurality of hooks that are inserted into the ground to secure the device. The device may also be comprised of a light source and a motion sensor to repel unwanted animals at night.

In this manner, the plant protection device of the present invention accomplishes all of the foregoing objectives and provides a novel means to keep animals from destroying plants or gardens. The device also prevents dogs or other animals from digging deep holes throughout the user's yard.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plant protection device. The device is comprised of a center attachment member, at least one protective arm, and at least one hook. The device is also comprised of at least one protective arm fastener that allows the protective arm to be removably attached to the center attachment member.

In one embodiment, the protective arms may be comprised of a wire mesh that connects the arms together. In this embodiment, there would be no gaps in between each protective arm thereby preventing even small animals from getting close to the plant. In one embodiment, the mesh may be in the form of a netting.

The protective arms are comprised of at least one stationary member and at least one adjustable member. The protective arms may be telescopic such that they can be adjusted to a plurality of lengths to further encompass a plurality of plant sizes and shapes.

In one embodiment, the adjustable member of the protective arm slides into the hollow stationary member to fully retract the protective arms into their smallest/most compact form. The adjustable member can then be pulled out from the stationary member and be placed at the desired length to ensure that the plant is fully protected.

The device is also comprised of at least one locking mechanism. On each adjustable member. The locking mechanism can be disengaged to move the adjustable member to its desired length. The locking mechanism can then be engaged to securely hold the adjustable member at the desired position without the risk of it moving.

The device is also comprised of at least one hook. In the preferred embodiment, the hook has a pointed end that allows the user to easily push the hook into the ground. This allows for a more secure application of the device.

The hook is further attached to the protective arm via a hook attachment fastener. The hook attachment fastener allows for a user to easily remove the hook from the protective arm. This allows the user to replace broken or dull hooks without having to replace the entire device. This allows for a cost-efficient method to protect the user's plants and garden.

The device is also comprised of at least one protective arm fastener, at least one light source, at least one motion sensor, at least one battery, and at least one solar panel.

The light source, when activated via motion sensor, is used to repel any unwanted animals that may attempt to destroy the user's plants/garden at night. In one embodiment, the light source may be powered by at least one battery. In another embodiment, the light source may receive its power from at least one solar panel. The solar panel may be positioned on the top of a protective arm.

In the preferred embodiment, the light source may be operated via motion sensor, further comprised of a processor. The processor is in electrical communication with the motion sensor. When an animal approaches the device, the motion sensor communicates with the processor which further turns on the light source. Then when the animal leaves and there is no movement for a period of time, the motion sensor communicates with the processor, which turns off the light source.

Accordingly, the plant protection device of the present invention is particularly advantageous as it provides a novel way to keep animals from digging up plants and holes in a user's yard/garden. In this manner, the plant protection device overcomes the limitations of plant protection devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a plant protection device of the present invention in accordance with the disclosed architecture;

FIG. 2 illustrates an enhanced perspective view of one potential embodiment of a plant protection device of the present invention in accordance with the disclosed architecture; and

FIG. 3 illustrates a flowchart of one potential method of using one potential embodiment of the plant protection device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a plant protection device. There is a long-felt need in the art for a device that stops animals from digging up plants and gardens. There also exists a long-felt need in the art for a device that is not an eyesore that helps protect growing plants. There also exists a long-felt need in the art for a plant protection device that can be easily installed with minimal effort. There also exists a long felt need in the art for a device that can restrict pets, such as dogs, from digging large holes throughout an individual's yard. There also exists a long-felt need in the art for a device that is cost efficient and is not a burden on the user.

The present invention, in one exemplary embodiment, is comprised of a plant protection device. The device is primarily comprised of a center attachment member, a plurality of protective arms, at least one hook, at least one light source, at least one motion sensor, at least one battery, and at least one locking mechanism. The center attachment member is comprised of a plurality of protective arm fasteners which allow the protective arms to be removably attached to the center attachment member for convenient assembly. The protective arms are comprised of a stationary member and an adjustable member. The adjustable member can be moved by the user to the desired length of the protective arm. This allows the device to cover a plurality of different size plants/holes. The adjustable member is then locked into place via a locking mechanism. The device is also comprised of hooks that are attached to the protective arms via hook attachment fasteners. The hooks are pushed into the ground for an even more secure protection.

The device is also comprised of a light source that is powered by at least one battery. In another embodiment the light source may be powered by at least one solar panel. The light source is further controlled and activated via a motion sensor that is in electrical communication with a processor. The motion sensor activates the light source if an animal is approaching the device, further protecting the user's plants at night.

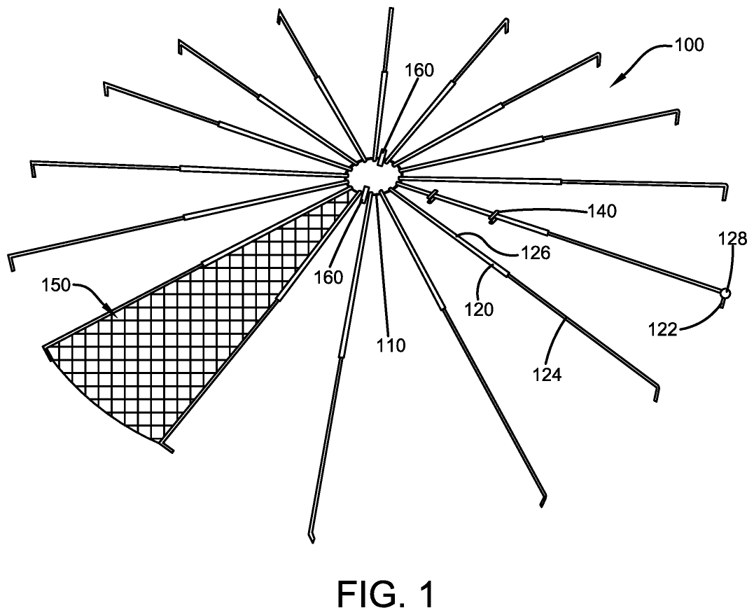

Referring initially to the drawings, FIG. 1 illustrates a perspective view of one potential embodiment of a plant protection device 100 of the present invention in accordance with the disclosed architecture. The device 100 is comprised of a center attachment member 110, at least one protecting arm 120, and at least one hook 122.

The center attachment member 110 is preferably manufactured from a metal material such as, but not limited to: stainless steel, aluminum, tin, iron, etc. In the preferred embodiment, the center attachment member 110 is comprised of a non-corrosive metal.

In a differing embodiment, the center attachment member 110 may be manufactured from a durable rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

The center attachment member 110 may be any shape or size known in the art such as, but not limited to, square, oval, triangle, rectangle, but preferably is circular.

The device 100 is also comprised of a plurality of protective arms 120. These protective arms 120 prevent animals from digging up plants the device 100 surrounds. In one embodiment, at least one webbing/netting/cover/mesh 150 is positioned between two arms 120 to prevent animals from digging between both arms while also allowing grass seed to be planted under the mesh 150 while still receiving water and sunlight. In the preferred embodiment, the protective arms 120 are manufactured from a non-corrosive metal material. In differing embodiments, the protective arms 120 may be manufactured from any metal or plastic material known in the art.

In differing embodiments, the wire mesh may be manufactured from any wire material known in the art such as copper, brass, bronze, nickel, titanium, silver, tungsten, molybdenum, molen, Inconel, nichrome, vinyl, galvanized steel, stainless steel, aluminum, or combinations thereof.

There is also a plurality of patterns that the wire mesh may be comprised such as, but not limited to, crimped wire mesh, twill weave, pre-crimp wire mesh, lock crimp wire mesh, inter-crimp wire mesh, non-crimped wire mesh, flat top weave, Dutch weave wire mesh, metal mesh edges, etc.

In another embodiment, the mesh may be in the form of a netting. The netting may be any netting known in the art that would keep animals away from the plants.

The protective arm 120 is comprised of at least one stationary member 126 and at least one adjustable member 124. All members 120,124,126 are preferably square or rectangular so that they cannot be rolled over. The protective arm 120 is preferably telescopic such that it can be adjusted to a plurality of lengths to further encompass a plurality of plant sizes and shapes.

In one embodiment, the adjustable member 124 of the protective arm 120 slides into the hollow stationary member 126 to fully retract the protective arm 120 into its smallest/most compact form. The adjustable member 124 can then be pulled out from the stationary member 124 and placed at the desired length to ensure that the plant is fully protected.

The device 100 is also comprised of at least one locking mechanism 140. The locking mechanism 140 can be disengaged to move the adjustable member 124 to its desired length. The locking mechanism 140 can then be engaged to securely hold the adjustable member 124 at the desired position without the risk of it moving.

The locking mechanism 140 may be any locking mechanism known in the art such as, but not limited to, a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock, a fixed core lock, or combinations thereof.

The device 100 is also comprised of at least one hook 122. The hook 122 preferably is manufactured from a metal material such as, but not limited to, stainless steel, aluminum, galvanized steel, or combinations thereof. In a differing embodiment, the hook 122 may be manufactured from any durable rigid plastic material known in the art.

In the preferred embodiment, the hook 122 has a pointed end that allows for the user to easily push the hook 122 into the ground. This allows for a more secure application of the device 100.

The hook 122 is further attached to the protective arm 120 via at least one hook attachment fastener 128. There are a plurality of fasteners that may be used such as, but not limited to, a magnet, a screw, a nut, a bolt, a carriage bolt, a nail, an anchor bolt, an acorn nut, a threaded rod, a retaining ring, a rivet, a set screw, a toggle bolt, an anchor, a self-tapping screw, an adhesive, a u-bolt, a lock nut, a castle nut, or combinations thereof.

The hook attachment fastener 128 allows for a user to easily remove the hook 122 from the protective arm 120. This allows the user to replace broken or dull hooks 122 without having to replace the entire device 100. This further allows for a cost-efficient method to protect the user's plants and garden.

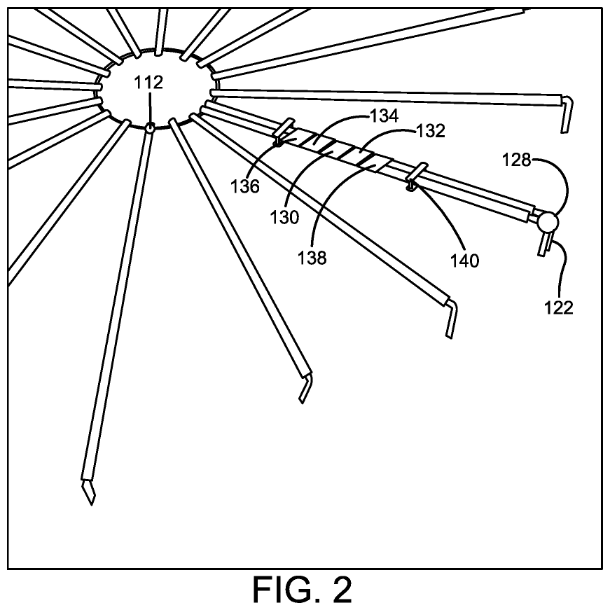

FIG. 2 illustrates an enhanced perspective view of one potential embodiment of the plant protection device 100 of the present invention in accordance with the disclosed architecture. The device 100 is comprised of at least one protective arm fastener 112, at least one light source 130, at least one motion sensor 132, at least one battery 134, and at least one solar panel 136.

The device 100 is comprised of at least one protective arm fastener 112. The protective arm fastener 112 allows the protective arm 120 to be removed from the center attachment member 110. This allows for easy disassembly and storage of the device 100.

The protective arm fastener 112 may be any fastener known in the art such as, but not limited to, a magnet, a screw, a bolt, an adhesive, a hook and loop fastener, a tongue and groove fastener, etc.

The device 100 may be comprised of a light source 130. The light source is preferably positioned on a protective arm. The light source 130 may be any light source such as, but not limited to, LED light, white light, fluorescent light, incandescent light, neon light, etc. The light source 130 is activated via motion sensor 132 and is used to repel any unwanted animals that may attempt to destroy the user's plants/garden at night. The light source 130 may illuminate continuously or intermittently once activated.

In one embodiment, the light source 130 may be powered by at least one battery 134. The battery 134 can be in the form of an alkaline, nickel-cadmium, nickel-metal hydride battery, etc., such as any 3V-12-volt DC battery 134 or other conventional battery 134 such as A, AA, AAA, etc., that supplies power to the light source 130 and/or motion sensor 132. Throughout this specification, the terms “battery” and “batteries” may be used interchangeably to refer to one or more wet or dry cells or batteries 134 of cells in which chemical energy is converted into electricity and used as a source of DC power. References to recharging or replacing batteries 134 may refer to recharging or replacing individual cells, individual batteries 134 of cells, or a package of multiple battery cells as is appropriate for any given battery 134 technology that may be used.

In another embodiment, the light source 134 may receive its power from at least one solar panel 136. The solar panel 136 may be located on the top of a protective arm 120. The solar panel 136 also may be any suitable solar panel 136 technology that is known in the art.

In the preferred embodiment, the light source 130 may be operated via a motion sensor 132 comprised of a processor 138. The processor 138 is in electrical communication with the motion sensor 132. When an animal approaches the device 100, the motion sensor 132 communicates with the processor 138 which turns on the light source 130.

Then when the animal leaves and there is no movement for a period of time, the motion sensor 132 communicates with the processor 138 which turns off the light source 130.

In one embodiment, the center attachment member 110 is comprised of at least one hinge 160. The hinge 160 may be any hinge type known in the art. The hinge 160 allows the device 100 to fold such that the device 100 forms a right angle (or other obtuse angle). In this manner, the device 100 can easily be positioned over an area near a fence, wherein the vertical portion of the folded device 100 contacts the fence.

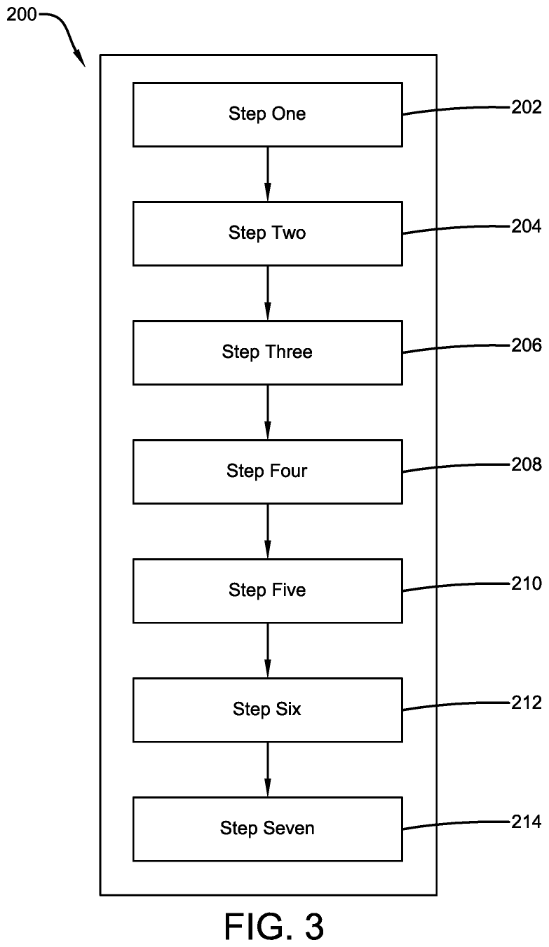

FIG. 3 illustrates a flowchart of one potential method 200 of using one potential embodiment of the plant protection device 100 of the present invention in accordance with the disclosed architecture. First, the user places the center attachment member 110 over the area in which the plant will grow [Step 202]. Then, the user attaches the protective arms 120 via the protective arm fasteners 112 [Step 204]. Next, the user attaches the hooks 122 to the protective arms 120 via the hook attachment fastener 128 [Step 206]. Then, the user extends the adjustable member 124 to the length that encompasses the area desired to be protected [Step 208]. Next, the user engages the locking mechanism 140 to ensure that the adjustable member 140 does not move [Step 210]. Then, the user pushes the hooks 122 into the ground for a more secure application [Step 212]. Finally, the user turns on the motion sensor 132 to ensure that the light source 130 will function properly [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plant protection device” and “device” are interchangeable and refer to the plant protection device 100 of the present invention.

Notwithstanding the foregoing, the plant protection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plant protection device 100 as shown in the FIGS. are for illustrative purposes only, and that many other sizes and shapes of the plant protection device 100 are well within the scope of the present disclosure. Although the dimensions of the plant protection device 100 are important design parameters for user convenience, the plant protection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant protection device comprising:
a center attachment member;
a protective arm; and
a hook.

2. The plant protection device of claim 1, wherein the center attachment member is a circular center attachment member.

3. The plant protection device of claim 1, wherein the center attachment member is comprised of a protective arm fastener.

4. The plant protection device of claim 3, wherein the protective arm fastener is comprised of a magnet, a screw, a bolt, an adhesive, a hook and loop fastener or a tongue and groove fastener.

5. The plant protection device of claim 1, wherein the hook is comprised of a pointed end.

6. The plant protection device of claim 1, wherein the protective arm is comprised of a stationary member.

7. The plant protection device of claim 1, wherein the protective arm is comprised of an adjustable member.

8. The plant protection device of claim 7, wherein the adjustable member is comprised of a locking mechanism.

9. The plant protection device of claim 1, wherein the hook is comprised of a hook attachment fastener.

10. A plant protection device comprising:
a center attachment member comprised of a protective arm fastener;
a protective arm comprised of a stationary member, an adjustable member and a locking mechanism;
a hook comprised of a hook attachment member;
a light source; and
a motion sensor.

11. The plant protection device of claim 10, wherein the light source is comprised of a LED light, a white light, a fluorescent light, an incandescent light or a neon light.

12. The plant protection device of claim 10, wherein the light source is comprised of a processor.

13. The plant protection device of claim 10 further comprising a battery.

14. The plant protection device of claim 10, wherein the light source is comprised of a solar panel.

15. The plant protection device of claim 10, wherein the locking mechanism is comprised of a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a Bluetooth lock that unlocks via a smart device mobile application, a mechanical dial lock, a numerical combination lock, a pedestal lock, a draw lock or fixed core lock.

16. The plant protection device of claim 10, wherein the protective arm is comprised of a wire mesh.

17. The plant protection device of claim 15, wherein the wire mesh is comprised of a copper, a brass, a bronze, a nickel, a titanium, a silver, a tungsten, a molybdenum, a molen, an Inconel, a nichrome, a vinyl, a galvanized steel, a stainless steel, or an aluminum material.

18. The plant protection device of claim 10, wherein the light source is positioned on the protective arm.

19. The plant protection device of claim 10, wherein the hook is comprised of a stainless steel, an aluminum or a galvanized steel material.

20. The method of using a plant protection device, the method comprising the steps of:
placing a center attachment member over an area;
attaching a protective arm to a center attachment member via a protective arm fastener;
attaching a hook to a protective arm via a hook attachment fastener;
extending an adjustable member and engaging a locking mechanism;
pushing a hook into the ground; and
turning on a motion sensor and light source.
